(19) United States
(12) Patent Application Publication
(10) Pub. No.: US 2004/0187144 A1
(43) Pub. Date: Sep. 23, 2004

(54) Optical pickup actuator and method

(75) Inventors: Dae-Jong Jang, Anyang-si (KR); Byung-Youn Song, Guwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/732,234

(22) Filed: Dec. 11, 2003

(30) Foreign Application Priority Data
Mar. 18, 2003 (KR) 03-16286

(51) Int. Cl. G11B 7/085

(52) U.S. Cl. 720/683

(57) ABSTRACT

An optical pickup actuator includes a blade holding an objective lens, a flexible support supporting the blade so that the blade is movable with respect to a holder installed on a base, a magnet installed on the base, and a pattern coil installed in the blade facing the magnet. The pattern coil has a tracking coil and at least one pair of focusing coils symmetrically disposed on either side of the tracking coil, and driving in the focusing and tilting directions is selectively performed depending on the direction current flows through the pair of focusing coils. In the above configuration, the actuator can easily perform tilting control as well as focusing and tracking control, thereby increasing precision of control.

### CROSS-REFERENCE TO RELATED APPLICATIONS

This application claims the benefit from Korean Patent Application No. 2003-16286, filed on Mar. 15, 2003, in the Korean Intellectual Property Office, the disclosure of which is hereby incorporated by reference.

### BACKGROUND OF THE INVENTION

1. Field of the Invention

The present invention relates to an optical pickup actuator, and more particularly, to an optical pickup actuator using a pattern coil.

2. Description of the Related Art

Optical pickups record information by scanning light through an objective lens onto a disc that is a recording medium while reproducing information by receiving light reflected from the disc. Typically, an optical pickup has an actuator for controlling the position of an objective lens so that light is emitted at the correct position on a disc.

FIG. 1 shows the structure of a conventional optical pickup actuator. The optical pickup actuator includes a blade 2 for holding an objective lens 1, a plurality of wires 7 for supporting the blade 2 so that it is movable with respect to a holder 3, and an electromagnetic driving unit for driving the blade 2 in a focusing direction Z and tracking direction X to control the position of the objective lens 1. The electromagnetic driving unit is comprised of a pair of magnets 5 positioned on a base 4 and a pattern coil 6 positioned in the blade 2 so that it is located between the pair of magnets 5.

When current is applied to the pattern coil 6, having a focusing coil 6a and tracking coils 6b positioned as shown in FIG. 2, an electromagnetic force is generated through an interaction with the magnets 5 to drive the blade 2. For example, as current flows through the tracking coils 6b, an electromagnetic force is generated in the direction indicated by arrow X. As current flows through the focusing coil 6a, an electromagnetic force is generated in the direction indicated by arrow Z. In some conventional actuators, a winding coil is installed at a predetermined position of the blade 2 instead of the pattern coil, but recently the pattern coil 6, more suitable for miniaturization of an optical pickup, is preferred.

Furthermore, as marketplace demands increase for actuators having precise control over the position of objective lens, a control of a tilting direction T (See FIG. 1) as well as control of a focusing direction Z and a tracking direction X is essentially required. However, the pattern coil 6 configured as shown in FIG. 2 only enables a driving in the focusing direction Z and the tracking direction X, but cannot drive the blade 2 in the tilting direction T.

As another example of a conventional electromagnetic driving unit, a pattern coil 6′ as shown in FIG. 3 has been proposed. In this example, a focusing coil 6a′ is disposed on the right side of the pattern coil body 6′ while a tracking coil 6b′ is disposed on the left side. A magnet 5′, corresponding to the pattern coil 6′, has three poles. Thus, when current is applied to the focusing coil 6a′ and the tracking coil 6b′, electromagnetic forces are generated in the directions indicated by arrows Z and X, respectively. However, the conventional pattern coil 6′ makes driving in the tilting direction T impossible while driving in the focusing direction Z and tracking direction X. Another drawback of the pattern coil 6′ is the difficulty in locating the magnet 5′ and the pattern coil 6′ close to each other since a magnetic field is created asymmetrically so that leakage flux affects the mutual electromagnetic forces in the focusing direction Z and tracking direction X. Thus, the required increase of distance between them reduces the control sensitivity.

For this reason, among others, an optical pickup actuator having an electromagnetic driving unit constructed to eliminate these drawbacks is highly desirable.

### SUMMARY OF THE INVENTION

The present invention provides an optical pickup actuator having a pattern coil that enables driving in the directions of focusing and tracking as well as in the tilting direction.

According to an aspect of the present invention, an optical pickup actuator is provided including a blade holding an objective lens, a flexible support supporting the blade so that the blade is movable with respect to a holder installed on a base, a magnet installed on the base, and a pattern coil installed in the blade to face the magnet. The pattern coil includes a tracking coil and at least one pair of focusing coils symmetrically disposed on either side of the tracking coil. Driving in the focusing and tilting directions is selectively performed depending on the direction current flows through the pair of focusing coils.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the will become apparent and more readily appreciated from the following description of the embodiments taken in conjunction with the accompanying drawings in which:

FIG. 1 shows a conventional optical pickup actuator;

FIG. 2 shows the electromagnetic driving unit of the optical pickup actuator of FIG. 1;

FIG. 3 shows another example of a conventional electromagnetic driving unit;

FIG. 4 shows an optical pickup actuator according an aspect of the present invention; and

FIGS. 5 and 6 show the electromagnetic driving unit of the optical pickup actuator of FIG. 4.

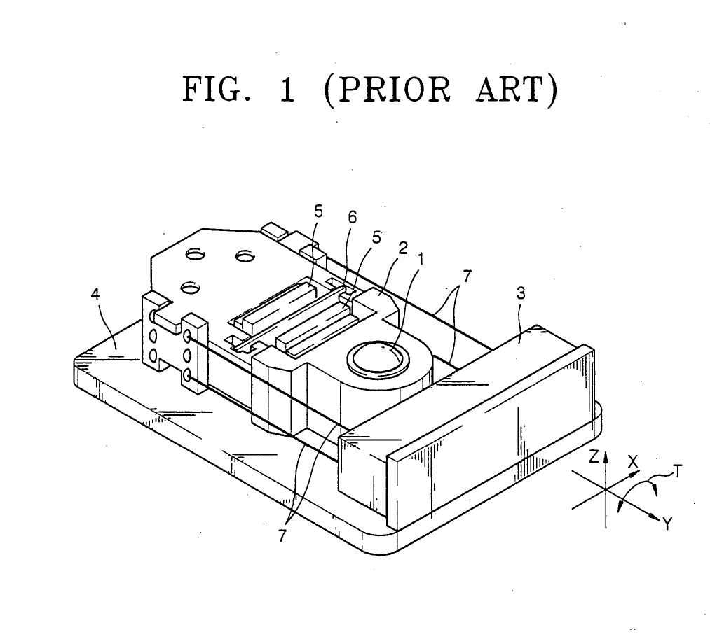

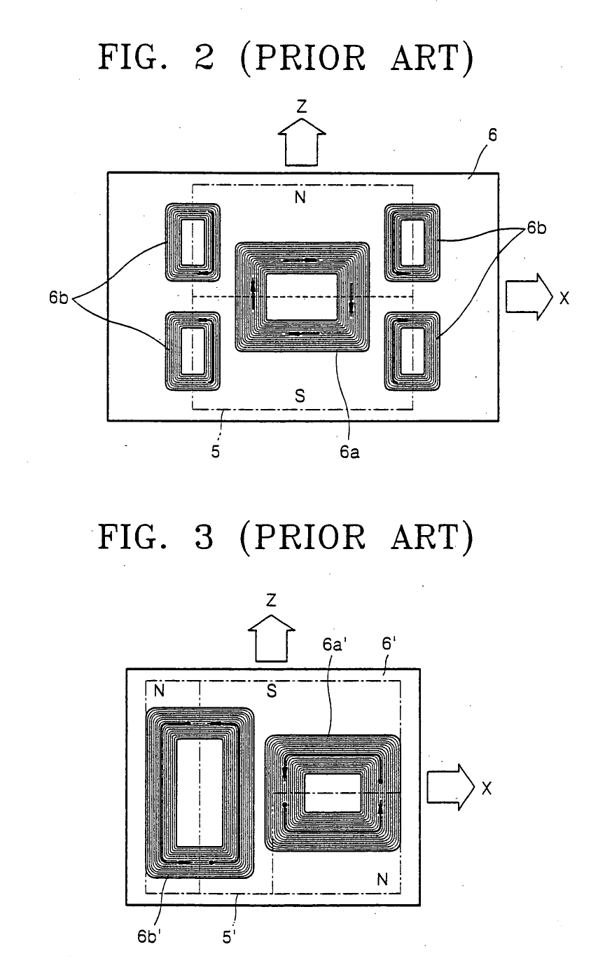

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

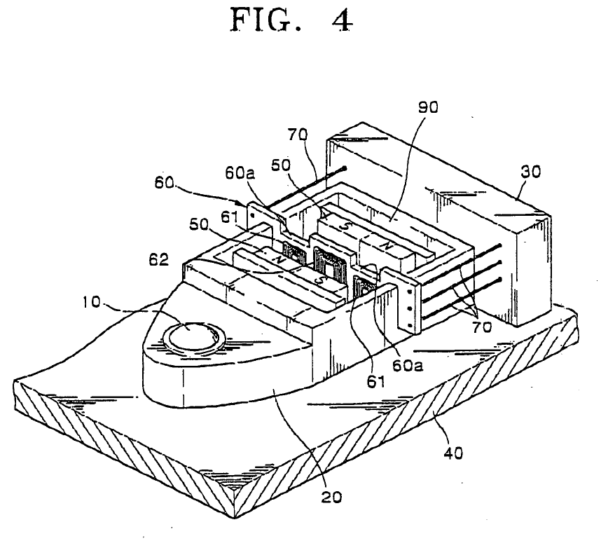

Referring to FIG. 4, an optical pickup actuator according an aspect of the present invention includes a holder 30 installed on a base 40, a blade 20 holding an objective lens 10 supported by a plurality of wires 70, which are a flexible support so that the blade 20 is movable with respect to the holder 30, and a electromagnetic driving unit driving the blade 20 in a focusing direction Z and a tracking direction X to control the position of the objective lens 10. Walls of the blade 20 define a cavity 90. The electromagnetic driving unit includes a pair of magnets 50 disposed on the base 40 to face each other and a pattern coil 60 installed between the pair of magnets 50 positioned inside the cavity 90 in the blade 20.

According to an aspect of the present invention, the pattern coil 60 is integrated with the blade 20 by insert molding. The pattern coil has one tracking coil 62 disposed at the center and a pair of focusing coils 61 symmetrically disposed on either side of the tracking coil 62. The plurality of wires 70, each with one end fixed to the holder 30, support flexible movement of the blade 20. The other end of each of plurality of wires 70 may be fixed by soldering to the pattern coil 60 integrated with the blade 20.

According to an aspect of the invention, the plurality of wires 70 serve as a supply line through which current is supplied to the pair of focusing coils 61 and the tracking coil 62. A connecting line (not shown) connects the soldered portion of each of the wires 70 to each of the coils 61 and 62 and is engraved in the pattern coil 60.

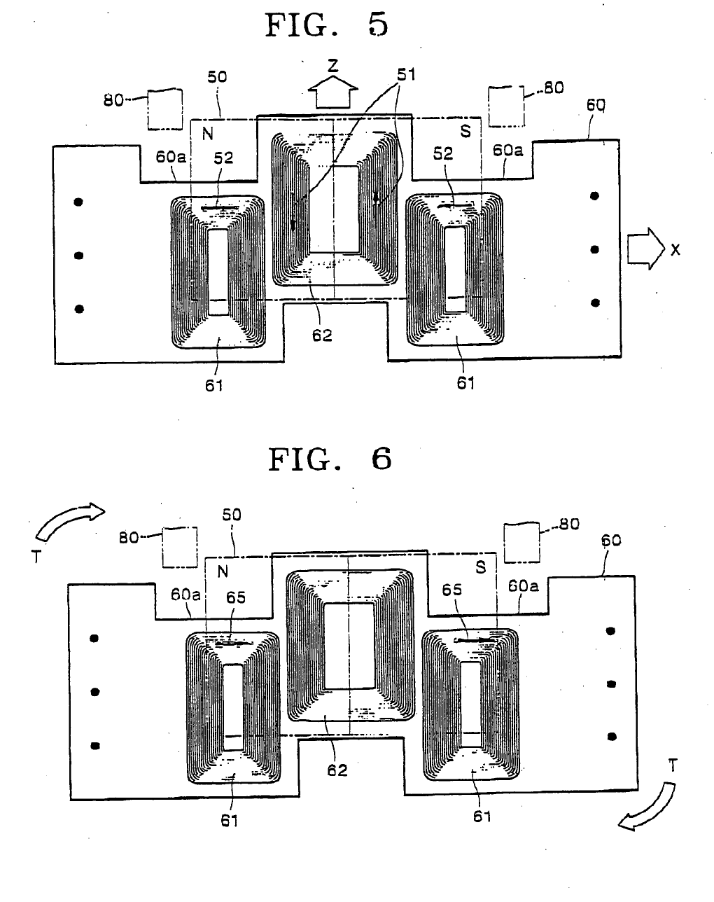

The pair of magnets 50 are divided into two poles with respect to a central vertical line of the tracking coil 62. FIG. 5 shows a projection view in which the magnets 50 face the pattern coil 60. An effective coil part of the tracking coil 62 used for generation of an electromagnetic force corresponds to the right and left substantially vertical portions of the tracking coil 62 while that of the focusing coils 61 corresponds to upper substantially horizontal portions of the focusing coils.

In the above configuration, if current flows through the tracking coil 62 in the direction indicated by arrows 51 in FIG. 5, an electromagnetic force is generated in the direction X according to Fleming's left hand rule. Thus, the pattern coil 60 and the blade 20, integrated with the pattern coil 60, are driven in the direction indicated by the arrow X. If current flows through the pair of focusing coils 61 in the directions indicated by arrows 52 in FIG. 5, an electromagnetic force is generated in the direction indicated by the arrow Z according to Fleming's left hand rule, and thus the pattern coil 60 and the blade 20 are driven in the direction indicated by the arrow Z.

When driving in the tilting direction is required, the actuator causes current to flow through each of the focusing coils 61 in the same direction as indicated by arrows 65 in FIG. 6. This generates electromagnetic forces in an upward direction in the focusing coil 61 located on the left side of the track coil 62, and in a downward direction in the focusing coil 61 on the right side. As a result, the pattern coil 60 and the blade 20 move in a clockwise direction. In contrast, if the actuator causes current to flow through the focusing coils 61 in the opposite direction to arrows 65, a driving force operates in a counterclockwise direction.

Thus, by controlling the direction that current flows through the pair of focusing coils 61, it is possible to have a driving force in the focusing direction Z as well as in the tilting direction T. Furthermore, since the magnets 50 are divided into two poles symmetrically with respect to the central vertical line of the tracking coil 62, the actuator according to an aspect of this invention can eliminate the adverse effect due to the asymmetrical structure shown in FIG. 3 of the conventional actuator.

Referring to FIG. 6, concave surfaces 60a are formed at the top of the body of the pattern coil. During operation of the actuator, the concave surfaces 60a may contact a stopper 80 limiting the height to which the blade 20 rises. The stopper 80 is installed on the inside of a cover (not shown) covering the optical pick-up actuator. The surface contacted by the stopper 80 is indented in this way to allow a long distance for moving the objective lens 10 in an upwardly or downwardly direction. Thus, if a long moving distance is needed for focusing control of the objective lens 10, it is effective to form the portion 60a contacted by the stopper 80 in a concave shape.

As described above, the optical pickup actuator according to aspects of the present invention has numerous advantages over conventional actuators. One advantage is that the actuator according to an aspect of the present invention can easily perform tilting control as well as focusing and tracking control, thereby increasing overall precision of control. Another advantage is the actuator provides a symmetric distribution of a magnetic field created by the magnet thereby increasing the stability of control.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical pickup actuator for use with an objective lens and a holder on a base, comprising:
a blade holding the objective lens, walls of the blade defining a cavity in the blade;
a flexible support movingly supporting the blade so that the blade is movable with respect to the holder;
at least one magnet installed on the base; and
a pattern coil installed inside the cavity and facing the magnet,
wherein the pattern coil comprises:
a tracking coil, and
at least one pair of focusing coils symmetrically disposed on either side of the tracking coil,
wherein driving in focusing and tilting directions is selectively performed depending on a direction a current flows through each of the focusing coils.

2. The actuator according to claim 1, wherein the magnet is divided into two poles with respect to a substantially vertical line passing through substantially the center of the tracking coil.

3. The actuator according to claim 2, wherein effective coil parts of the tracking coil generating an electromagnetic force correspond to substantially vertical portions of the tracking coil.

4. The actuator according to claim 2, wherein effective coil parts of the focusing coils generating electromagnetic forces correspond to upper, substantially horizontal portions of the focusing coils.

5. The actuator according to claim 2, wherein a current flowing in opposite directions in each of the focusing coils in the pair of focusing coils generates a force moving the blade in the focusing direction.

6. The actuator according to claim 2, wherein a current flowing in a same direction in each of the focusing coils in the pair of focusing coils generates a force moving the blade in the tilting direction.

7. The actuator according to claim 1, wherein the pattern coil is integrated with the blade by insert molding.

8. The actuator according to claim 7, wherein the flexible support has one end fixed to the holder and the other end fixed to the pattern coil.

9. The actuator according to claim 7, further comprising a connecting line connecting a soldered portion of the flexible support to the tracking coil and the at least one pair of focusing coils.

10. The actuator according to claim 8, wherein the connecting line is engraved in the pattern coil.

11. The actuator according to claim 1, wherein a concave indentation is formed at a top of a body of the pattern coil.

12. The actuator according to claim 11, further comprising a stopper disposed above the blade,
wherein the concave indentation is formed at the top of the body of the pattern coil so that the stopper contacts the concave surface when the blade moves up to a predetermined height.

13. The actuator according to claim 1, wherein the flexible support is a plurality of wires supplying current to the tracking coil and the at least one pair of focusing coils.

14. A method to increase the stability of control of a blade holding an objective lens of an optical pickup actuator, comprising:
controlling a direction of flowing current through a tracking coil portion of a pattern coil positioned between a pair of magnets in the optical pickup actuator, wherein each of the magnets is divided into two poles with respect to a substantially vertical line passing through substantially the center of the tracking coil;
controlling a direction of flowing current through each focusing coil portion of a pair of focusing coil portions of the pattern coil, the focusing coil portions positioned symmetrically in relation to the substantially vertical line;
generating a plurality of forces from the flowing current to move the blade; and
moving the blade with the plurality of generated forces in at least one of a focusing direction, a tracking direction, and a tilting direction.

15. The method according to claim 14, wherein current flowing in opposite directions in each of the focusing coil portions in the pair of focusing coil portions generates a force moving the blade in a focusing direction.

16. The method according to claim 14, wherein a current flowing in a same direction in each of the focusing coil portions in the pair of focusing coil portions generates a force moving the blade in the tilting direction.

17. An optical pickup actuator for use with an objective lens and a holder on a base, comprising:
a movable blade holding the objective lens, walls of the blade defining a cavity in the blade;
a magnet installed on the base;
a pattern coil, having a concave indentation at the top of a body of the pattern coil, positioned in the cavity,
wherein the pattern coil comprises:
a tracking coil, and
a pair of focusing coils symmetrically disposed on either side of the tracking coil.

18. The actuator according to claim 17, wherein a direction of movement of the blade is selectively performed depending on a direction a current flows through each of the pair of focusing coils and the tracking coil.

19. The actuator according to claim 17, wherein the concave indentation lengthens a range of movement of the blade.

20. The actuator according to claim 19, further comprising a stopper disposed above the blade,
wherein the range of movement of the blade is restricted by the stopper contacting the concave indentation when the blade moves up to a predetermined height.
